(19) United States
(12) Patent Application Publication
(10) Pub. No.: US 2024/0358189 A1
(43) Pub. Date: Oct. 31, 2024

(54) FOOD HEATER WITH FRONT-FACING LIFT-OUT ROLLERS

(71) Applicant: C. Cretors & Company, Wood Dale, IL (US)

(72) Inventors: Kristen A. Brennan, Arlington Heights, IL (US); Karl R. Heinze, West Chicago, IL (US); Nilesh J. Darji, Niles, IL (US); Nenad Vidojevic, Chesterton, IN (US)

(21) Appl. No.: 18/306,914

(22) Filed: Apr. 25, 2023

(51) Int. Cl. A47J 37/04

(52) U.S. Cl. CPC A47J 37/048; A47J 37/049

(57) ABSTRACT

Food heaters with front-facing lift-out rollers are disclosed herein. In some embodiments, a food heater can pivot between a first position (e.g., a cooking position) and a second position (e.g., a cleaning position) with the use of a lift system. In some embodiments, the food heater can include rollers that are supported by an integrated support structure of a drip tray when in the first position. In some embodiments, the rollers extend toward a user and can be removed in a direction toward the user when in the second position.

### TECHNICAL FIELD

The present disclosure generally relates to devices for rotating and heating food such as hot dogs, sausages, bratwurst, and the like.

### BACKGROUND

Conventional devices for heating hot dogs typically include tubular rollers that support the hot dogs. Such devices can also include electric heating elements positioned inside the rollers for heating the hot dogs, and a drive system for rotating the rollers and turning the hot dogs. The hot dogs are rotated and heated due to contact with the rollers. As the hot dogs are heated, the rollers can become covered with juices that naturally cook out of the hot dogs. One downside of conventional hot dog heating devices, however, is that they can be difficult and time consuming to clean (e.g., to remove the juices from the rollers). For example, many conventional hot dog heating devices require that the device be disassembled for cleaning, and a relatively large amount of space may be required to facilitate disassembly. Many hot dog heating devices, however, are positioned on crowded counters (e.g., in a convenience store, concession stand, etc.) where space for disassembly is limited.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIGS. 1A and 1B are perspective views of a food heater system including a food heater in a first position and a second position, respectively, configured in accordance with embodiments of the present technology.

FIG. 1C is a perspective view of the food heater system including the food heater of FIGS. 1A and 1B in the first position configured in accordance with embodiments of the present technology.

FIGS. 2A and 2B are perspective views of the food heater of FIGS. 1A-C in the first position and the second position, respectively, configured in accordance with embodiments of the present technology.

FIG. 3 is an enlarged perspective rear view of a drive unit of the food heater of FIGS. 1A-2B configured in accordance with embodiments of the present technology.

FIG. 4 is an enlarged perspective front view of a portion of the drive unit of the food heater of FIGS. 1A-2B configured in accordance with embodiments of the present technology.

FIGS. 5A and 5B are enlarged perspective rear views of a drip tray of the food heater of FIGS. 1A-2B with the food heater in the first position and the second position, respectively, in accordance with embodiments of the present technology.

FIG. 6A is a bottom view of a lift system of the food heater of FIGS. 1A-2B configured in accordance with embodiments of the present technology.

FIGS. 6B and 6C are enlarged bottom and side views, respectively, of portions of the lift system of FIG. 6A in rest positions in accordance with embodiments of the present technology.

FIGS. 6D and 6E are enlarged bottom and side views, respectively, of the portions of the lift system of FIGS. 6B and 6C in lift positions in accordance with embodiments of the present technology.

FIGS. 7A and 7B are perspective views of a food heater in a first position in accordance with additional embodiments of the present technology.

FIG. 7C is a perspective view of the food heater of FIGS. 7A and 7B in a second position in accordance with embodiments of the present technology.

FIG. 7D is an enlarged perspective front view of a portion of the food heater of FIGS. 7A-7C configured in accordance with embodiments of the present technology.

FIG. 8 is a bottom view of a food heater with an induction wire in accordance with embodiments of the present technology.

FIG. 9 is a front view of the food heater of FIG. 8 in accordance with embodiments of the present technology.

### DETAILED DESCRIPTION

The present technology is generally directed to devices for rotating and heating food such as hot dogs, sausages, bratwurst, and/or the like. In some embodiments, for example, a food heater can pivot between a first position (e.g., a cooking position) and a second position (e.g., a cleaning position) with the use of a lift system. In some embodiments, the food heater can include rollers that are at least partially supported by a support structure comprising a drip tray when in the first position. In some embodiments, the rollers extend toward a user and can be removed in a direction toward the user when in the second position.

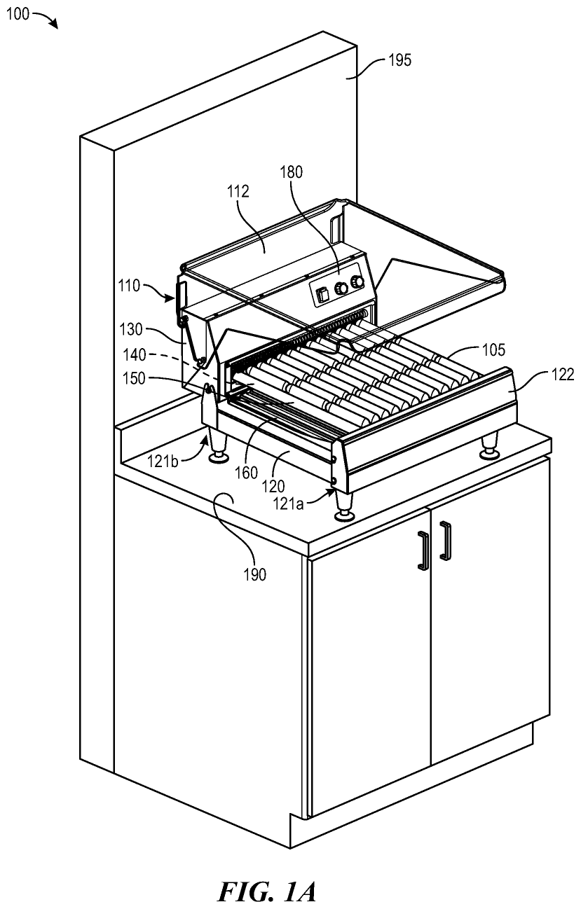

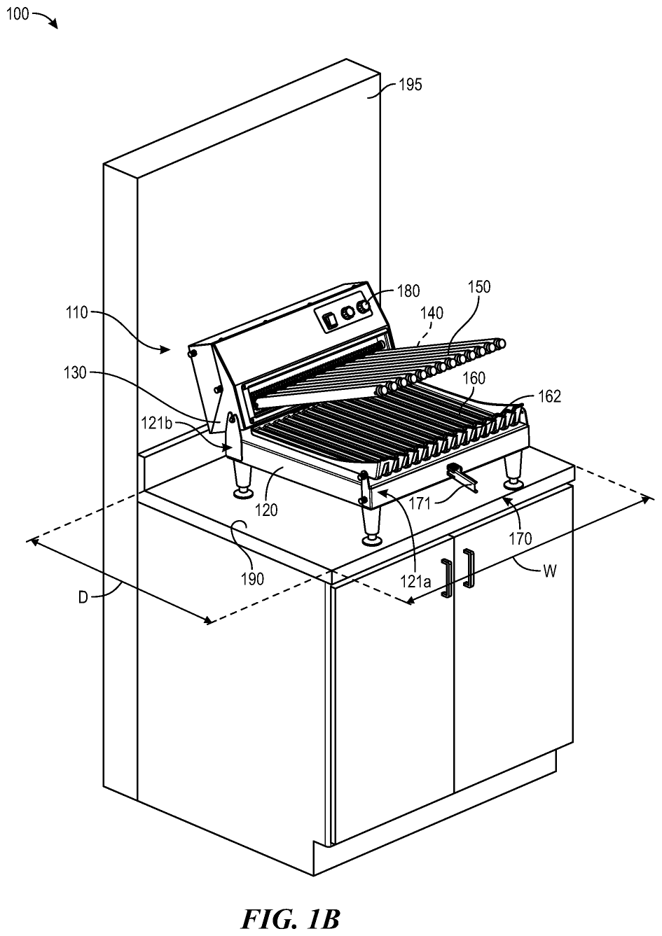

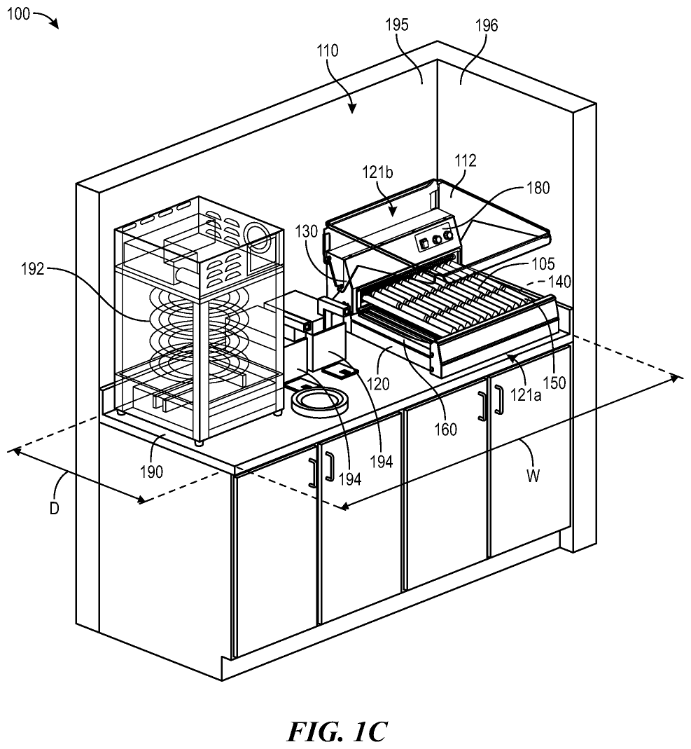

Certain details are set forth in the following description and in FIGS. 1A-9 to provide a thorough understanding of various embodiments of the present technology. In other instances, well-known structures, materials, operations and/or systems often associated with food heaters, motors, drive systems, lift systems, and the like are not shown or described in detail in the following disclosure to avoid unnecessarily obscuring the description of the various embodiments of the present technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIGS. 1A and 1B.

FIGS. 1A and 1B are perspective views of a food heater system 100 including a food heater 110 in a first position and a second position, respectively, in accordance with embodiments of the present technology. In the food heater system 100, the food heater 110 can be placed atop a counter 190 in a food-serving setting (e.g., a convenience store, a concession stand). In some embodiments, the counter 190 includes or is positioned adjacent a rear wall 195, and has a width W and a depth D as shown in FIG. 1B. The food heater 110 includes a base 120, a drive unit 130 rotatably coupled to the base 120, a plurality of heaters 140 (e.g., heating elements) fixedly coupled to the drive unit 130, a plurality of rollers 150 rotatably coupled to or mounted over corresponding ones of the heaters 140, a drip tray 160 (e.g., a drip pan) positioned between the base 120 and the rollers 150, a lift system 170 positioned underneath the base 120, and a control panel 180 coupled to the drive unit 130. The heaters 140 are obscured by the rollers 150 in FIGS. 1A and 1B.

The base 120 has a rear portion 121b configured to, for example, face the wall 195 and a user-facing portion 121a (e.g., a front portion) opposite the rear portion 121b. In the illustrated embodiment, the drive unit 130 is mounted to the rear portion 121b, and the rollers 150 are accessible by a user at the user-facing portion 121a. The food heater 110 can include a sneeze guard 112 removably coupled to the drive unit 130. The sneeze guard 112 is removed from the food heater 110 in FIG. 1B. In some embodiments, the food heater 110 can include some features that are at least generally similar in structure and function, or identical in structure and function, to any of the food heaters described in U.S. patent application Ser. No. 16/812,334, titled “FOOD HEATERS, SUCH AS FOR USE IN HEATING HOT DOGS,” and filed Mar. 8, 2020, which is incorporated herein by reference in its entirety.

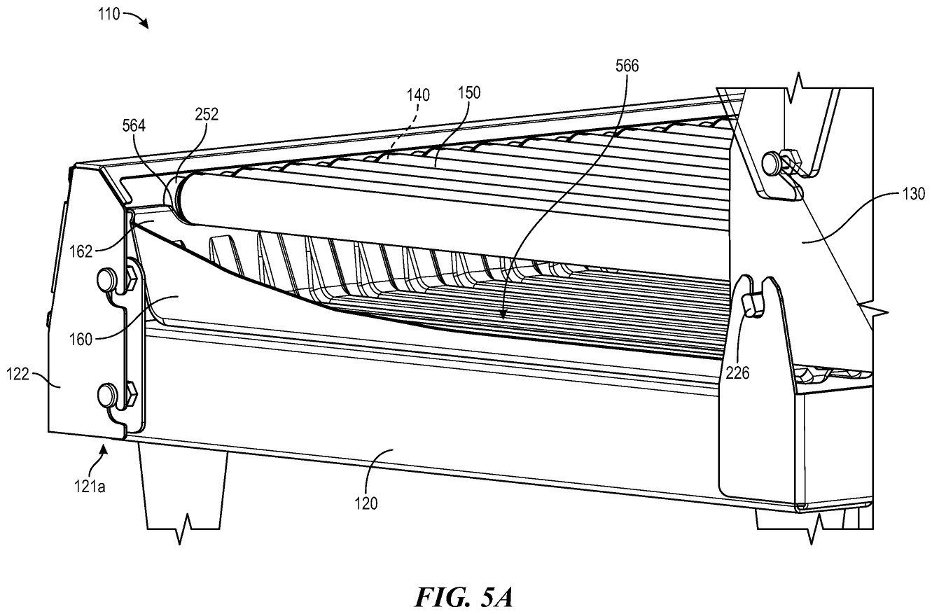

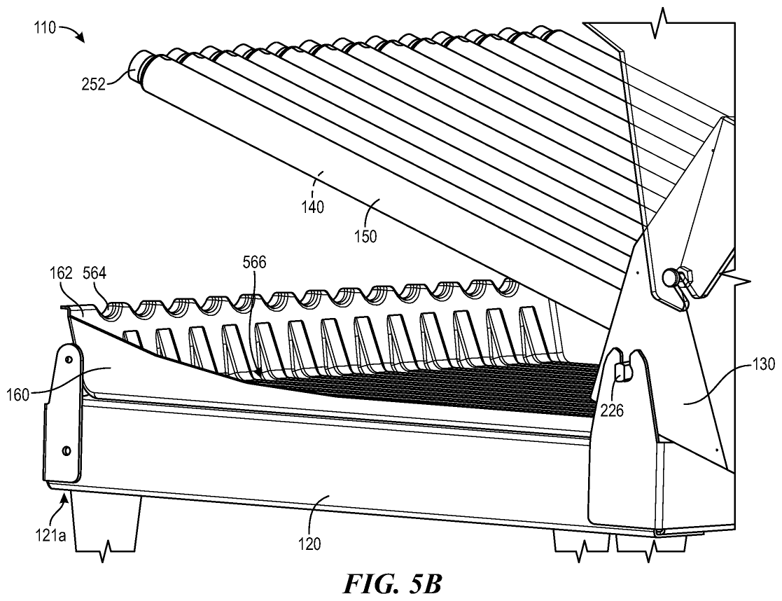

Referring to FIG. 1A, when the food heater 110 is in the first position, the rollers 150 (and the heaters 140 extending therein) can extend generally parallel to the base 120 and can be used to roll and/or cook food products 105 (e.g., hot dogs, sausages, bratwurst). Power is supplied to the plurality of heaters 140, which provide heat to the rollers 150 and the food products 105. Power is also supplied to the drive unit 130, which rotates the rollers 150 around corresponding ones of the heaters 140. Proximate to the rear portion 121b, the heaters 140 and the rollers 150 are coupled to and supported by the drive unit 130. Proximate to the user-facing portion 121a, the heaters 140 and the rollers 150 are supported by the drip tray 160. More specifically, the heaters 140 and the rollers 150 can be supported proximate to the user-facing portion 121a by a support structure 162 (FIG. 1B) of the drip tray 160 described in detail below with reference to FIGS. 5A and 5B. The food heater can also include a front shield 122 removably coupled to or proximate to the user-facing portion 121a. The front shield 122 is removed from the food heater 110 in FIG. 1B.

The control panel 180 can include one more user-actuatable controls for controlling the heat provided by the heaters 140, a rate of rotation of the rollers 150, etc., and/or one or more displays, indicator lights, etc., for providing information about a cooking process and/or operational state of the food heater 110 to a user of food heater 110. In the illustrated embodiment, the control panel 180 is mounted to the drive unit 130 to face the user-facing portion 121a of the base 120.

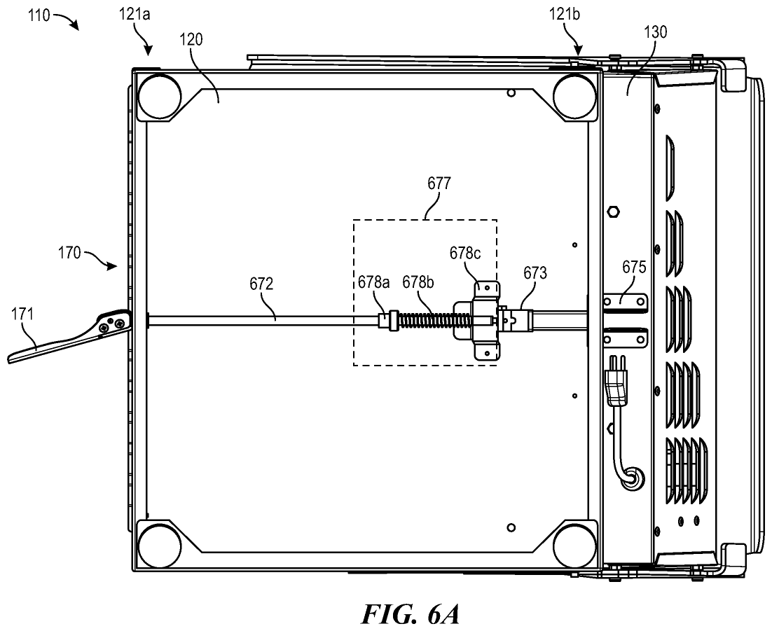

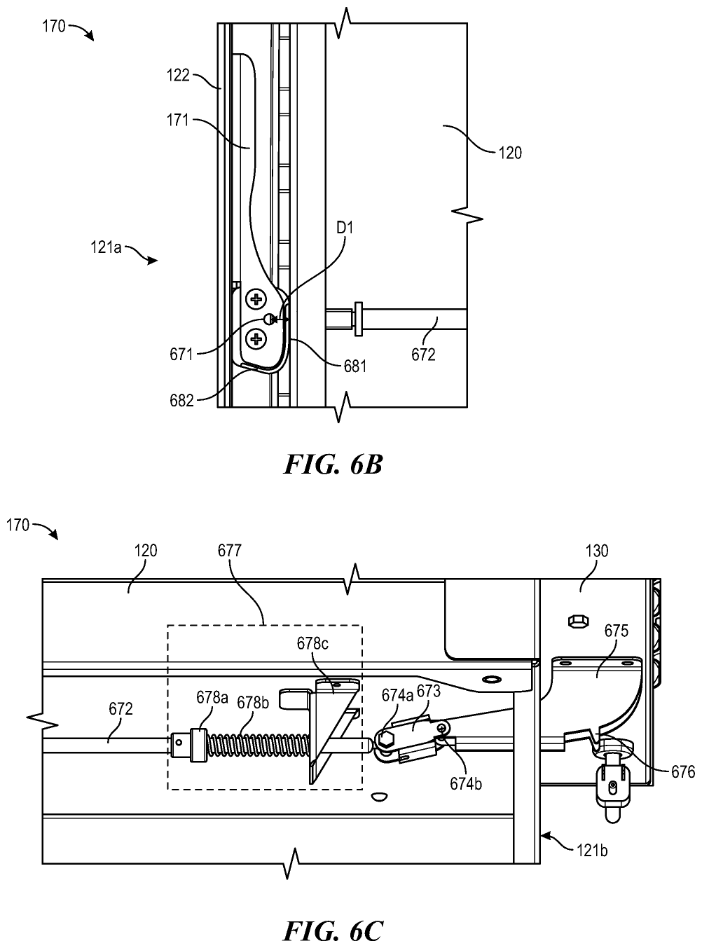

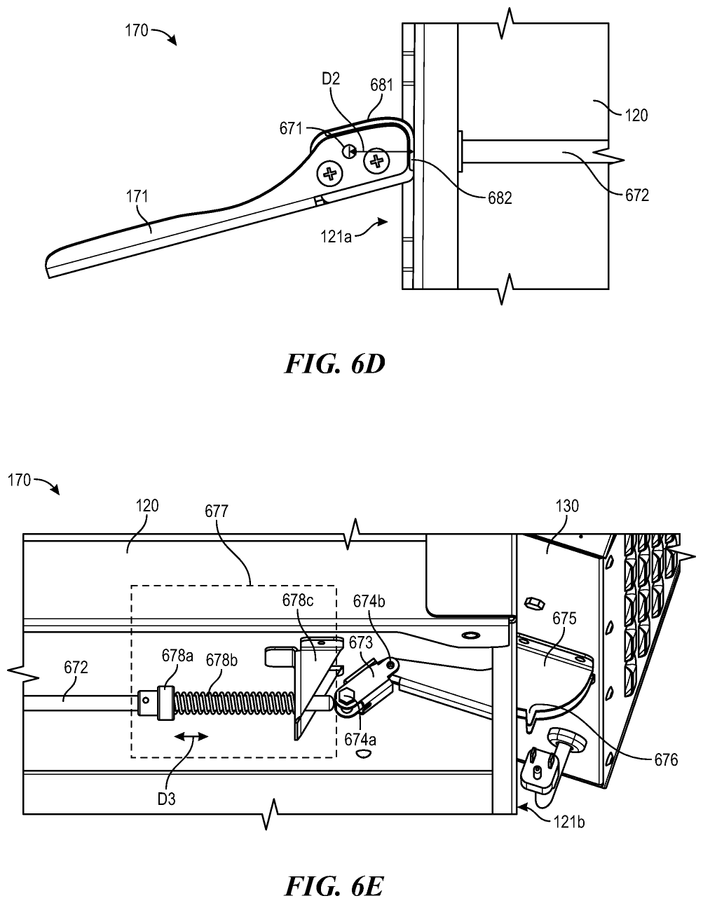

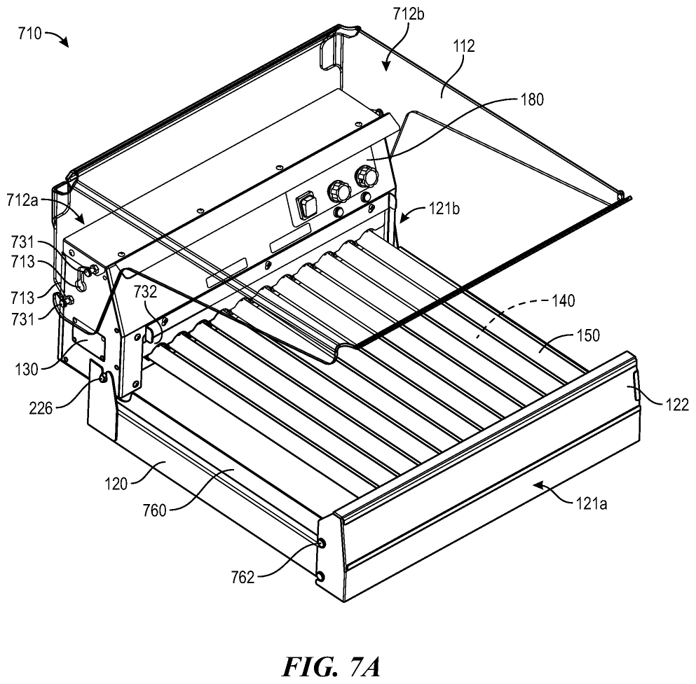

Referring to FIGS. 1A and 1B, to pivot the food heater 110 from the first position to the second position, the front shield 122 can be removed from the base 120 (the front shield 122 is removed in FIG. 1B) to provide access to a handle 171 (e.g., a cam handle) of the lift system 170. The handle 171 can be coupled to the user-facing portion 121a of the base 120. As described in detail below with reference to FIGS. 6A-6E, actuating (e.g., pulling) the handle 171 can actuate the lift system 170 to pivot the drive unit 130 from the first position (FIG. 1A) to the second position (FIG. 1B) and vice versa. In some embodiments, the sneeze guard 112 is removably coupled to the drive unit 130 and can be removed from the drive unit 130 as shown in FIG. 1B to facilitate access to the rollers 150.

Referring to FIG. 1B, when the food heater 110 is in the second position, the plurality of heaters 140 and the plurality of rollers 150 extend at a non-parallel angle (e.g., an acute angle) relative to the base 120 and are no longer supported by the support structure 162 of the drip tray 160. The rollers 150 can be removed from over the heaters 140 by pulling and/or pushing them in a direction facing away from the drive unit 130 (e.g., for cleaning, replacement).

FIG. 1C is a perspective view of the food heater system 100 in the first position in accordance with additional embodiments of the present technology. In the illustrated embodiment, the width W of the counter 190 is greater than the width W shown in FIG. 1B, and the counter 190 is further positioned adjacent a side wall 196. Referring to FIGS. 1A-1C, the food heater 110 is positioned on the counter 190 such that the rollers 150 extend away from the rear wall 195 (e.g., perpendicular to the rear wall 195) and/or parallel to the side wall 196, and the control panel 180 faces away from the rear wall 195. Likewise, the handle 171 (FIG. 1B) is positioned away from the rear wall 195 for easy access by a user of the food heater 110. This configuration allows the rollers 150 to be removed in the second position (FIG. 1B) in a direction away from the rear wall 195 and in a direction away from the side wall 196. In some aspects of the present technology, this allows the rollers 150 to be removed even when other obstructions (e.g., cash registers, other food heaters, product displays) are positioned on the counter 190 to the left and/or right of the food heater 110, such as the side wall 196 shown in FIG. 1C, a pizza heater 192 shown in FIG. 1C, condiment dispensers 194 shown in FIG. 1C, and/or the like. That is, the rollers 150 can be removed without being obstructed by the side wall 196, the pizza heater 192, the condiment dispensers 194, and/or other components adjacent the food heater 110. In contrast, some conventional food heaters have rollers extending left and right relative to the user (e.g., extending parallel to the rear wall 195) such that the rollers are difficult to access. Accordingly, orienting the rollers 150 such that they extend between the rear portion 121b and the user-facing portion 121a of the base 120 allows the rollers 150 to be removed in a less obstructed direction.

Further, typically, the depth D of the counter 190 is fixed but additional space can be available along the width W of the counter 190—such as by removing the pizza heater 192, the condiment dispensers 194, and/or any other components positioned adjacent the food heater 110 along the width W of the counter 190, as shown in FIG. 1C. Accordingly, to increase a food-heating capacity of the food heater 110 (e.g., to allow the food heater 110 to heat more of the food products 105 at the same time), additional ones of the heaters 140 and the rollers 150 can be added to increase a width of the food heater 110. The additional heaters 140 and rollers 150 can be identical to those shown in FIGS. 1A-1C having, for example, the same length. In contrast, if the food heater 110 were oriented with the heaters 140 and the rollers 150 extending parallel to the wall 195, the heaters 140 and the rollers 150 would need to be lengthened to increase the food-heating capacity of the food heater 110. Accordingly, orienting the heaters 140 and the rollers 150 as shown in FIGS. 1A-1C can provide for the food heater 110 to be made larger without increasing a length of the heaters 140 and the rollers 150. In some aspects of the present technology, this can enable the rollers 150 to be easily removed from over the heaters 140 as they do not require a large amount of open space to be removed by virtue of their relatively small length. In contrast, the longer rollers 150 required to increase the food-heating capacity of the food heater 110 if oriented parallel to the wall 195 would require significant space to remove from over the correspondingly longer heaters 140-in an environment (e.g., along the width W of the counter 190) in which space is likely to be limited.

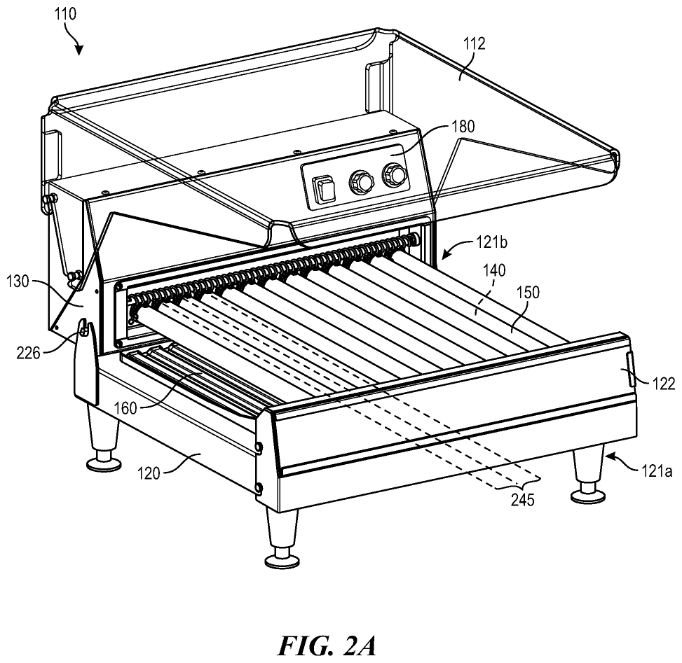

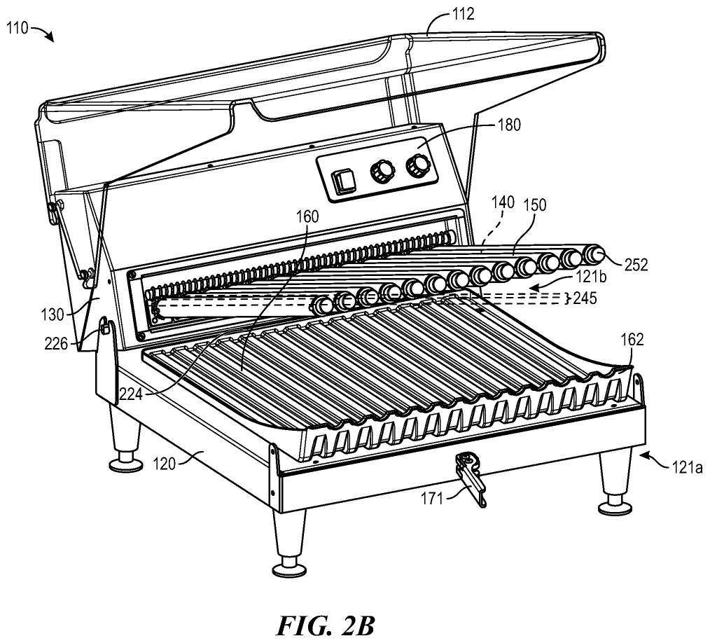

FIGS. 2A and 2B are perspective views of the food heater 110 of FIGS. 1A and 1B in the first position and the second position, respectively, in accordance with embodiments of the present technology. Referring to FIG. 2A, individual ones of the heaters 140 and the rollers 150 extend along a longitudinal axis 245. The longitudinal axes 245 can be parallel to one another, and the heaters 140 and the rollers 150 can extend concentrically along the corresponding ones of the longitudinal axes 245 (e.g., can be concentrically aligned with the corresponding ones of the longitudinal axes 245). The control panel 180 is coupled to the drive unit 130 and positioned to face in a direction substantially parallel to the longitudinal axes 245. The drive unit 130 supports the heaters 140 and the rollers 150 proximate to the rear portion 121b, and the drip tray 160 supports the heaters 140 and the rollers 150 proximate to the user-facing portion 121a. The front shield 122 can be removed to access the handle 171 for pivoting the food heater 110 from the first position to the second position. The drive unit 130 can pivot relative to the base 120 about a pivot hinge 226.

Referring to FIG. 2B, the drive unit 130, the heaters 140, and the rollers 150 are pivoted away from the base 120 in the second position such that the longitudinal axes 245 are positioned at an angle (e.g., a non-parallel angle) to the base 120. The control panel 180 remains positioned to face in the direction substantially parallel to the longitudinal axes 245. The food heater 110 can further include a plurality of end caps 252 that seal corresponding ones of the rollers 150. When the food heater 110 is in the first position (FIG. 2A), the support structure 162 of the drip tray 160 can contact the end caps 252 when supporting the heaters 140 and the rollers 150. When the food heater 110 is in the second position, the heaters 140, the rollers 150, and the end caps 252 are pivoted away from the support structure 162 such that the support structure 162 does not contact the end caps 252. In the second position, the rollers 150 can be removed from over the heaters 140 for cleaning, servicing, maintenance, and/or the like. The end caps 252 can, but need not, be removed from the rollers 150 when removing the rollers 150. The rollers 150 can be manually removeable from over the corresponding ones of the heaters 140 without the use of tools.

In some embodiments, the food heater 110 can also include a bracket 224 coupled to the base 120 proximate to the rear portion 121b. The bracket 224 can be used for positioning the drip tray 160 atop the base 120. The bracket 224 can also have a Z-shaped cross-section and extend over a portion of the drip tray 160 and prevent the drip tray 160 from moving vertically when the support structure 162 contacts the end caps 252 when supporting the heaters 140 and the rollers 150 in the first position (FIG. 2A). The bracket 224 can also relieve stress on welded joints of the heaters 140. In some embodiments, the bracket 224 can be omitted.

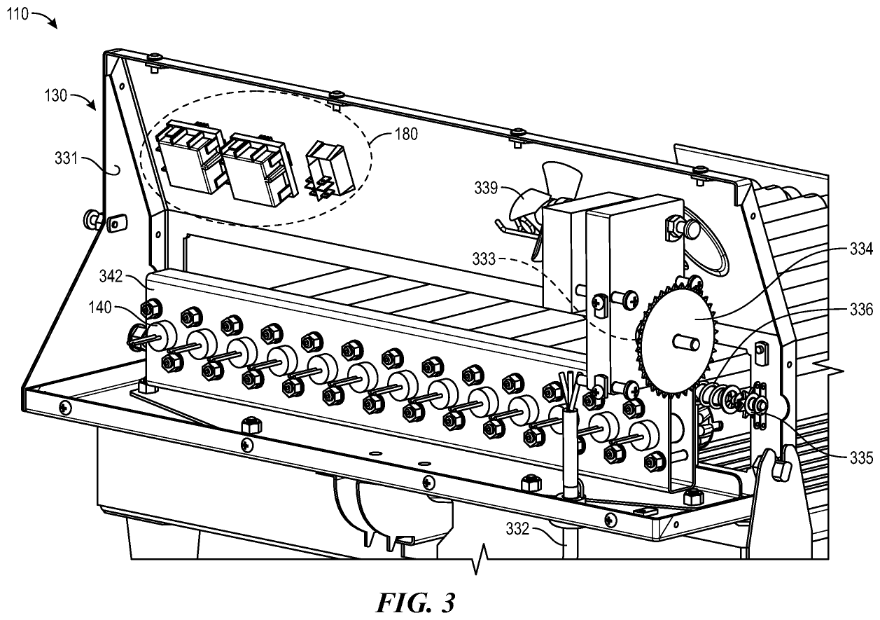

FIG. 3 is an enlarged perspective rear view of the drive unit 130 of the food heater 110 of FIGS. 1A-2B in accordance with embodiments of the present technology. In the illustrated embodiment, the drive unit 130 includes a housing 331 to which a heater bracket 342 is fixedly coupled. A rear panel of the housing 331 is removed in FIG. 3 for clarity. The heaters 140 are fixedly coupled to the heater bracket 342 such that when the drive unit 130 pivots from the first position to the second position, the heaters 140 also pivot accordingly. The drive unit 130 can also include a fan 339 that cools various components inside the housing 331. The control panel 180 (and components thereof) can be coupled to the housing 331. Each of the heaters 140, the fan 339, and/or the control panel 180 can receive power from a power supply line 332 during operation.

The power supply line 332 can also supply power to a motor 333 (e.g., an electric motor) fixedly coupled to the housing 331. The motor 333 can rotate a first drive gear 334 coupled to the motor 333. The first drive gear 334 can be coupled to a second drive gear 335 via a drive chain (not shown), and the second drive gear 335 can be fixedly coupled to a spool 336 (e.g., a worm gear). Operation of the motor 333 can be controlled to rotate the spool 336 at a desired rate. In other embodiments, the drive unit 130 can have other suitable components and/or arrangements for rotating the spool 336. For example, the motor 333 can be positioned in other locations within or external to the drive unit 330, the motor 333 can be coupled directly to the spool 336, etc.

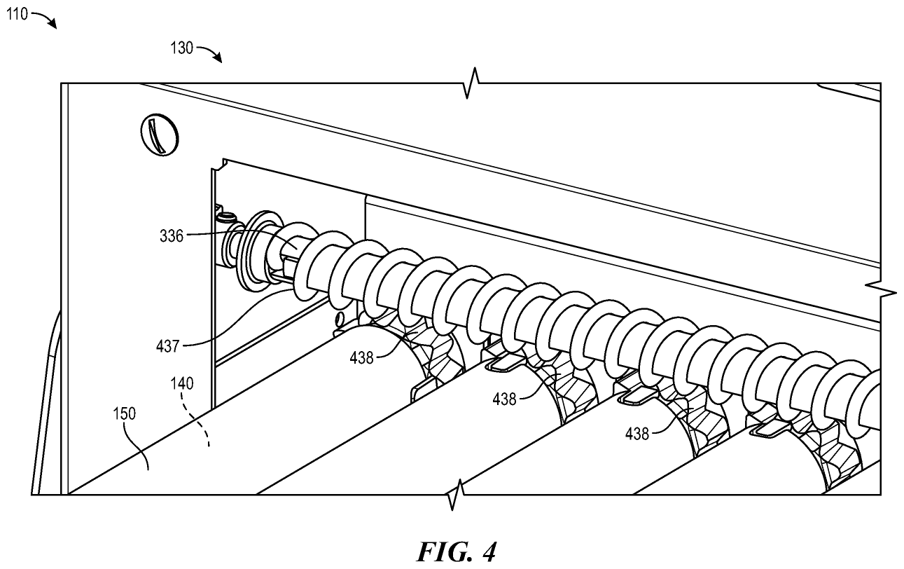

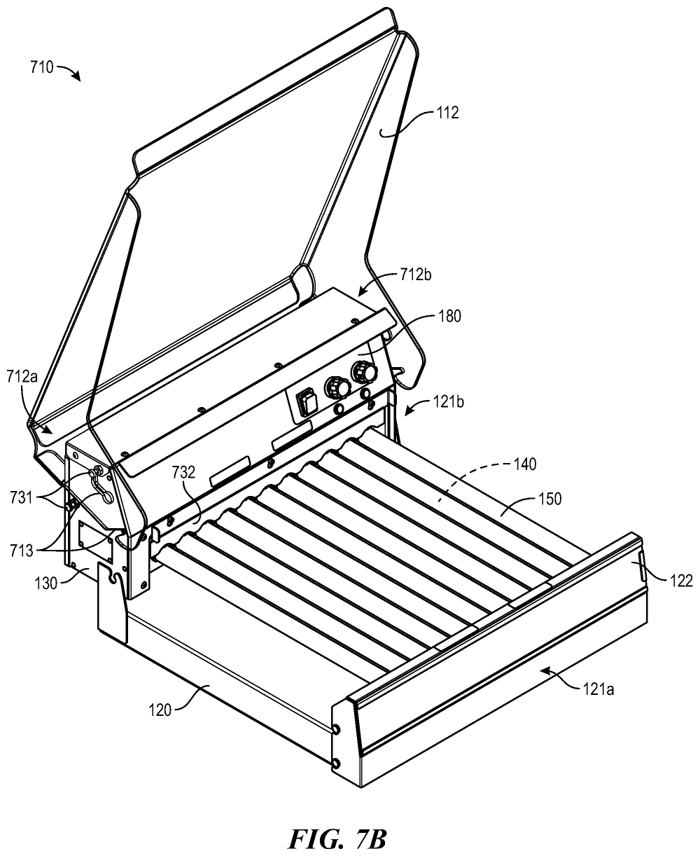

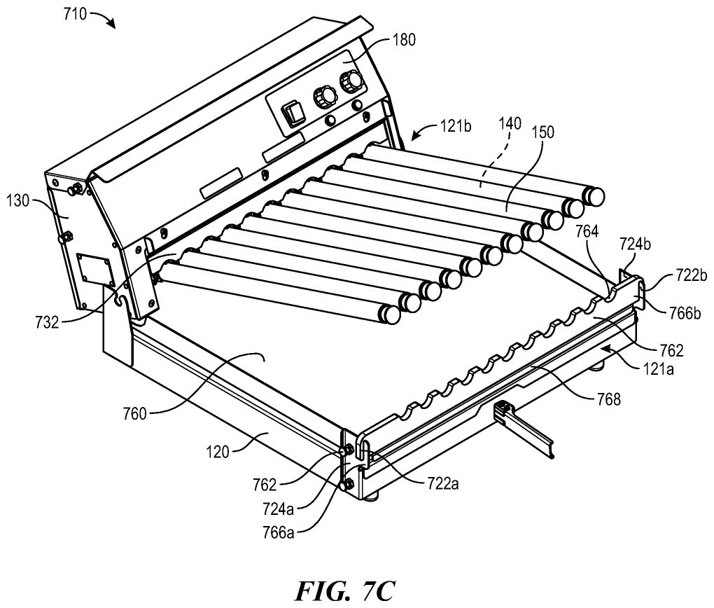

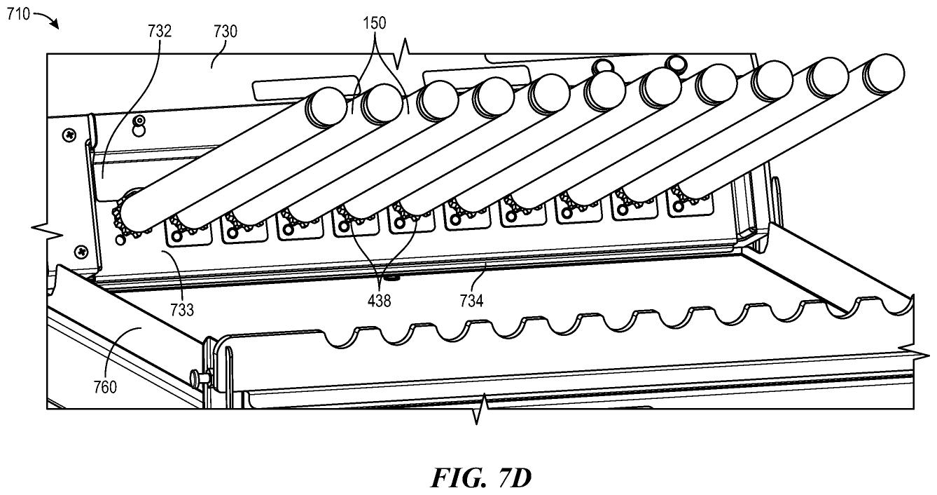

FIG. 4 is an enlarged perspective front view of the drive unit 130 in accordance with embodiments of the present technology. The drive unit 130 further includes a drive member 437 fixedly coupled to (e.g., coiled around) the spool 336 and a plurality of sprockets 438 coupled to the rollers 150. The drive member 437 engages (i.e., meshes with) teeth of the sprockets 438 in a worm drive gear arrangement. The sprockets 438 are coupled to corresponding ones of the rollers 150 such that rotation of the drive member 437 (e.g., via operation of the motor 333 shown in FIG. 3) rotates the rollers 150 positioned over corresponding ones of the heaters 140. In the illustrated embodiment, the rollers 150 and the sprockets 438 have generally the same dimensions as one another such that each of the rollers 150 rotates at approximately the same rate. In this manner, the rollers 150 can rotate food products 105 (e.g., hot dogs) placed in a gap between an adjacent pair of the rollers 150 at a generally constant rate without imparting differential stresses on the food product. In some embodiments, rotation of the drive member 437 pulls the sprockets 438 toward the drive unit 130. In some embodiments, the housing 331 includes a deflector that extends below the sprockets 438 and directs any grease or juices toward the drip tray 160 (not shown), preventing drippage behind the food heater 110. Such a deflector is described in detail below with reference to FIGS. 7A-7C. In other embodiments, the housing 331 does not include a deflector and includes an opening below the sprockets 438 for improved cleanability.

FIGS. 5A and 5B are enlarged perspective rear views of the drip tray 160 of the food heater 110 in the first position and the second position, respectively, in accordance with embodiments of the present technology. As illustrated in FIG. 5A, when in the first position, the plurality of heaters 140 and the plurality of rollers 150 are supported by the support structure 162 of the drip tray 160 proximate to the user-facing portion 121a of the base 120. More specifically, the support structure 162 can include a plurality of grooves 564 that support corresponding ones of the heaters 140 and the rollers 150 in the first position. In the illustrated embodiment, the grooves 564 only contact the end caps 252 coupled to the rollers 150. In other embodiments, the grooves 564 additionally or alternatively contact other components to support the heaters 140 and the rollers 150. For example, the grooves 564 can directly contact and support the rollers 150. In some embodiments, the support structure 162 is integrated with the drip tray 160. For example, the support structure 162 can comprise a portion of the drip tray 160 and/or the support structure 162 and the drip tray 160 can comprise a single unitary structure.

As illustrated in FIG. 5B, when in the second position, the drive unit 130 is pivoted relative to the base 120 about the pivot hinge 226. The heaters 140 and the rollers 150 are no longer supported by the grooves 564 proximate to the user-facing portion 121a of the base 120, but instead supported primarily by the drive unit 130. In some embodiments, the number of the rollers 150 and the number of grooves 564 on the support structure 162 are greater than five. The drip tray 160 can also include a plurality of indentations 566 positioned below corresponding ones of the rollers 150 that can collect liquid (e.g., juices, grease) from food products falling during and after cooking. In other embodiments, the indentations 566 can be positioned between corresponding pairs of rollers 150. In other embodiments, the drip tray 160 does not include the indentations 566, or the indentations 566 can have a different arrangement.

In some aspects of the present technology, the support structure 162 advantageously forms an integral component of the drip tray 160, reducing the number of individual components. The engagement of the rollers 150 with the support structure 162 within the grooves 564 also help prevent the drip tray 160 from shifting positions during operation (e.g., cooking). Moreover, the drip tray 160 can be made of a heat-resistant material, allowing the support structure 162 to contact the end caps 252, the heaters 140, and/or the rollers 150 without being damaged. The drip tray 160 can also be removed for cleaning and/or replacement when in the second position. In some embodiments, the drip tray 160 is fixedly coupled to the base 120.

FIG. 6A is a bottom view of the lift system 170 of the food heater 110 in accordance with embodiments of the present technology. FIGS. 6B and 6C are an enlarged bottom and side view, respectively, of the lift system 170 in a rest position corresponding to the first position of the food heater 110 in accordance with embodiments of the present technology. FIGS. 6D and 6E are an enlarged bottom and side view, respectively, of the lift system 170 in a lift position corresponding to the second position of the food heater 110 in accordance with embodiments of the present technology.

Referring to FIGS. 6A-6E together, the lift system 170 can be positioned underneath the base 120 and assist a user in switching the food heater 110 between the first and second positions. For example, a user can actuate (e.g., pull and/or push) the handle 171 (e.g., an actuation latch) positioned proximate to the user-facing portion 121a to actuate the lift system 170 to pivot the drive unit 130 from the first position to the second position or from the second position to the first position. When the lift system 170 is in the rest position (FIGS. 6B and 6C), the food heater 110 is in the first position, and when the lift system is in the lift position (FIGS. 6A, 6D, 6E), the food heater 110 is in the second position. In the illustrated embodiment, the lift system 170 further includes a lift shaft 672 coupled to the handle 171, a lift bracket 675 coupled to the drive unit 130, a linkage 673 coupled between the lift shaft 672 and the lift bracket 675, and a biasing assembly 677 coupled to the base 120 and the lift shaft 672.

The lift shaft 672 is pivotably coupled to the handle 171 about a pivot point 671 (FIGS. 6B and 6D). In some embodiments, the handle 171 is not coupled to, but merely contacts the base 120, and the pivot point 671 serves as the only coupling point between the handle 171 and the food heater 110.

The biasing assembly 677 includes a lift collar 678a fixedly coupled to the lift shaft 672, a support structure 678c fixedly coupled to the base 120, and a spring member 678b coupled between the lift collar 678a and the support structure 678c and positioned (e.g., coiled) around the lift shaft 672. As described in detail below with reference to FIGS. 6C and 6E, the biasing assembly 677 can bias the lift system 170 toward the lift position such that the force required to pivot the food heater 110 from the first position to the second position is reduced.

Referring to FIGS. 6B and 6C, which show the lift system 170 in the rest position and the food heater 110 in the first position, the front shield 122 can be disposed proximate to the user-facing portion 121a of the base 120. The front shield 122 can cover the handle 171 to obscure the handle 171 from view and/or prevent accidental actuation of the handle 171 during operation (e.g., when the food heater 110 is in the first position and being used to cook food products).

The lift shaft 672 is pivotably coupled to a first end portion 674a of the linkage 673, and the lift bracket 675 is pivotably coupled to a second end portion 674b of the linkage 673. The pivot point 671 is at a first distance D1 (FIG. 6B) from a side portion 681 of the handle 171 such that the lift shaft 672, the linkage 673, and the lift bracket 675 are in the rest position and the drive unit 130 (coupled to the lift bracket 675) is in the first position. The side portion 681 can contact the base 120. The first distance D1 can be predetermined based on the shape and dimensions of the handle 171. The lift shaft 672 is positioned relative to the base 120 such that the lift collar 678a, which is fixedly coupled to the lift shaft 672, compresses the spring member 678b against the support structure 678c, which is fixedly coupled to the base 120. The compressed spring member 678b exerts a force against the lift collar 678a, and hence against the lift shaft 672 as well, toward the user-facing portion 121a such that the biasing assembly 677 biases the lift system 170 toward the lift position.

Referring to FIGS. 6D-E, which show the lift system 170 in the lift position and the food heater 110 in the second position, the front shield 122 can be removed from the base 120 to allow user access to the handle 171. In some embodiments, when the handle 171 is actuated (e.g., pulled), the side portion 681 no longer contacts the base 120, and an end portion 682 of the handle 171 contacts the base 120 instead. The pivot point 671 remains aligned with the lift shaft 672 but moves farther away from the base 120 to a second distance D2 (FIG. 6D). The second distance D2 can be predetermined based on the shape and dimensions of the handle 171. As a result, the lift shaft 672 and the lift collar 678a are pulled toward the user-facing portion 121a by a third distance D3 (FIG. 6E). The third distance D3 is the difference between the first distance D1 and the second distance D2. The spring member 678b, which biases the lift system 170 toward the lift position, reduces the force necessary to actuate the handle 171. When the lift system 170 is in the lift position, as shown, the spring member 678b can remain compressed (to a lesser degree) or become uncompressed.

As the lift shaft 672 is pulled toward the user-facing portion 121a, the first end portion 674a of the linkage 673 is also pulled toward the user-facing portion 121a. The linkage 673 further pulls the lift bracket 675 toward the user-facing portion 121a. However, because the drive unit 130 rotates about the pivot hinge 226 (shown in, e.g., FIGS. 2A-B) and the lift bracket 675 is fixedly coupled to the drive unit 130, the second end portion 674b of the linkage 673 moves upward. The lift bracket 675 can include one or more protrusions 676 that can contact the rear portion 121b of the base 120 and prevent the drive unit 130 from rotating beyond a predetermined maximum angle relative to the base 120 about the pivot hinge 226. In other embodiments, the geometry of the lift system 170 is sufficient to prevent the drive unit 130 from rotating beyond a predetermined maximum angle and, accordingly, the protrusions 676 can be omitted.

When the food heater 110 is ready to be moved back to the first position (e.g., after cleaning and/or replacement of the rollers 150), the user can actuate the handle 171 in an opposite manner to drive the lift system 170 back to the rest position. For example, as the handle 171 is rotated from the lift position (FIG. 6D) to the rest position (FIG. 6B), the lift shaft 672 and the lift collar 678a are pushed toward the rear portion 121b such that the spring member 678b becomes compressed or is compressed to a greater degree against the support structure 678c. Because the heaters 140, the rollers 150, and the drive unit 130 are lifted in the second position, their weight can apply a torque on the lift bracket 675 such that the force required from the user to actuate the handle 171 to drive the lift system 170 back to the rest position is reduced.

In some embodiments, the spring member 678b is under tension, and not compression, such that the biasing assembly 677 biases the lift system 170 toward the rest position, reducing the amount of force necessary to move the lift system 170 from the lift position to the rest position.

FIGS. 7A and 7B are perspective views of a food heater 710 in a first position (e.g., a cooking position, and operating position) in accordance with embodiments of the present technology. FIG. 7C is a perspective view of the food heater 710 in a second position (e.g., a lifted position, a cleaning position, a maintenance position) in accordance with embodiments of the present technology. Referring to FIGS. 7A-7C, the food heater 710 can include some features that are at least generally similar in structure and function, or identical in structure and function, to the corresponding features of the food heater 110 described in detail above with reference to FIGS. 1A-6E, and can operate in a generally similar or identical manner to the food heater 110. Accordingly, like components are referenced with the same reference numbers. For example, the food heater 710 includes the base 120, the drive unit 130 rotatably coupled to the base 120, the heaters 140 fixedly coupled to the drive unit 130, the rollers 150 mounted over corresponding ones of the heaters 140, the sneeze guard 112, the control panel 180, etc.

Referring to FIGS. 7A and 7B, in the illustrated embodiment the sneeze guard 112 is rotatably coupled to the drive unit 130 such that the sneeze guard 112 can be pivoted upward from a first position (FIG. 7A) to a second lifted position (FIG. 7B) to provide access to the control panel 180, the rollers 150, and/or other components of the food heater 710. More specifically, the sneeze guard 112 can include a first side portion 712a and a second side portion 712b that include grooves 713 configured to receive corresponding pins/projections 731 of the drive unit 130. The sneeze guard 112 can be rotated about the pins 731 between the first and second positions, and the grooves 713 can guide rotation of the sneeze guard 112. In some embodiments, the first and second side portions 712a, 712b of the sneeze guard 112 can be flexed outward (i.e., away from the drive unit 130) to decouple the sneeze guard 112 from the drive unit 130.

Referring to FIGS. 7A-7C, the food heater 710 further includes a drive unit guard 732 coupled to the drive unit 130. The guard 732 is positioned to inhibit or even prevent food products placed on the rollers 150 from contacting the sprockets 438 (FIG. 4), the driver member 437 (FIG. 4), and/or other components of the drive unit 130. In some embodiments, the guard 732 includes a plurality of cutouts shaped to extend around the rollers 150 such that the guard 732 substantially extends around the rollers 150 without contacting the rollers 150. That is, the guard 732 can have an undulating lower edge that tracks the shape of the rollers 150.

In the illustrated embodiment, the food heater 710 further includes a drip tray 760 (e.g., a drip pan) positioned on and/or coupled to the base 120. In some embodiments, the drip tray 760 extends further toward the rear portion 121b and extends further sideways (i.e., in a direction perpendicular to the rollers 150) relative to the drip tray 160 described in detail above with reference to FIGS. 5A and 5B. Accordingly, the drip tray 760 can cover a relatively larger portion of the base 120. FIG. 7B illustrates the food heater 710 with the drip tray 760 removed.

Referring to FIG. 7C, removing the front shield 122 from the food heater 710 allows a user to access to a roller support structure 762. The roller support structure 762 can include a plurality of grooves 764 that support corresponding rollers 150 when the food heater is in the first position (FIGS. 7A and 7B), similar to the grooves 564 described in detail above with reference to FIGS. 5A and 5B. However, in the illustrated embodiment, the roller support structure 762 is not integrated with the drip tray 760 and is instead a separate component removably coupled to the base 120 and/or the drip tray 760. For example, in some embodiments the food heater 710 includes (i) a first bracket 724a coupled to a first side portion of the base 120 and having a first slot 722a and (ii) a second bracket 724b coupled to a second side portion of the base 120 opposite the first side portion and the first bracket 724a and having a second slot 722b. The roller support structure 762 can be removably coupled to the brackets 724a, 724b by inserting the roller support structure 762 into the first and second slots 722a, 722b. In some embodiments, the roller support structure 764 can include/define third and fourth slots 766a, 766b that can mate with and engage the first and second slots 722a, 722b to secure the roller support structure 762 to the brackets 724a, 724b. The roller support structure 762 can additionally or alternatively be removably coupled to the drip tray 760. In the illustrated embodiment, the roller support structure 762 is positioned over a distal end portion of the drip tray 760 such that the drip tray 760 can catch any juices that accumulate on and fall from the roller support structure 762. More specifically, the drip tray 760 can include a lip portion 768, and the roller support structure 762 can be removably positioned on/over the lip portion 768. In some embodiments, the lip portion 768 includes an upwardly extending protrusion and the roller support structure 762 includes an aperture that receives the protrusion. The drip tray 760 and the roller support structure 762 can be removed together or independently from the base 120.

FIG. 7D is an enlarged perspective front view of a portion of the food heater 710 of FIGS. 7A-7C configured in accordance with embodiments of the present technology. In the illustrated embodiment, the drive unit 730 includes/defines a recess 732 having a recessed wall 733 to which the rollers 150 and the sprockets 438 are mounted. In some aspects of the present technology, the recess 732 provides an opening below the sprockets 438 and the rollers 150 that facilitates easier cleaning of the food heater 710 as, for example, any juices, grease, and/or cooking byproducts are free to drip directly from the sprockets 438 and the rollers 150 into the drip tray 760. In some embodiments, the drive unit 730 further includes a deflector 734 coupled thereto or integrally formed therewith for deflecting the juices, grease, and/or cooking byproducts away from a rear portion of the drive unit 730 and toward/into the drip tray 760.

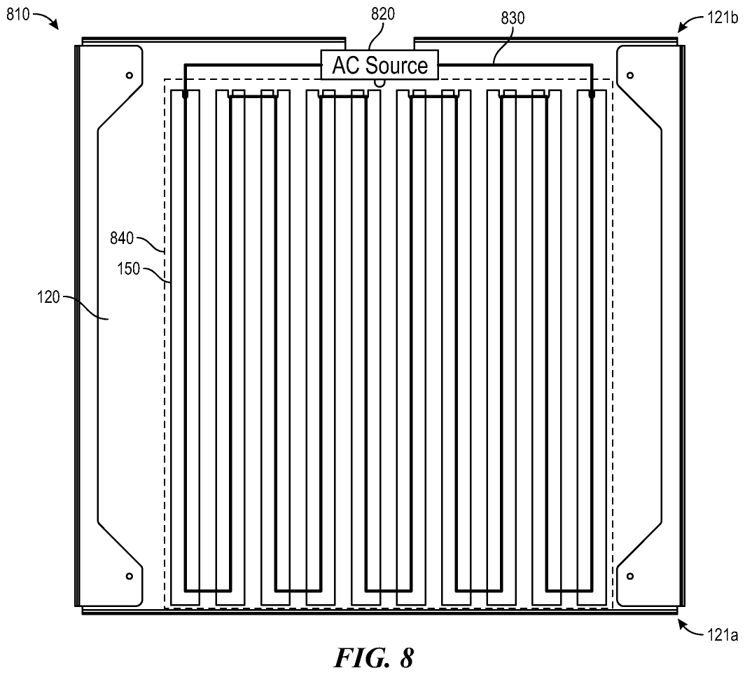

FIG. 8 is a bottom view of a food heater 810 with an induction heating source in accordance with embodiments of the present technology. The food heater 810 can include some features that are at least generally similar in structure and function, or identical in structure and function, to the corresponding features of the food heater 110 and/or the food heater 710 described in detail above with reference to FIGS. 1A-7D, and can operate in a generally similar or identical manner to the food heater 110 and/or the food heater 710. Accordingly, like components are referenced with the same reference numbers. For example, the food heater 810 includes the base 120 and the rollers 150 rotatably mounted over the base 120.

In the illustrated embodiment, the induction heating source of the food heater 810 includes an alternating current (AC) source 820 coupled to an induction wire 830. The AC source 820 and the induction wire 830 can be positioned inside, below, or above the base 120. The induction wire 830 can be laid out such that a single strand of wire extends along (e.g., below) each of the rollers 150, as shown. Accordingly, current flowing through the induction wire 830 flows in only one direction under each of the rollers 150. In some embodiments, the induction wire 830 can include multiple wire strands extending under each of the rollers 150 such that the current flows in the same direction through the wire strands under each of the rollers 150. In some aspects of the present technology, this layout is advantageous over embodiments with multiple strands of wire extending along each roller 150 that route current in opposite directions because the electromagnetic fields generated by the current flowing in adjacent strands can cancel each other out and reduce the efficiency of induction heating. In the illustrated embodiment, the AC source 820 is positioned proximate to the rear portion 121b. In other embodiments, the AC source 820 can be positioned elsewhere (e.g., proximate to the user-facing portion 121a, proximate to side portions of the base 120).

The AC source 820 can provide power to the induction coil 830 such that the current flowing in the induction wire 830 inductively heats the rollers 150. In some embodiments, the rollers 150 are made of a ferromagnetic material or other material appropriate for induction heating (e.g., stainless steel). In some embodiments, the food heater 810 includes a non-magnetic, insulating board 840 made of, for example, glass. In the illustrated embodiment, the food heater 810 can omit heaters (e.g., the heaters 140) positioned within each of the rollers 150 because the rollers 150 are inductively heated by the induction coil 830. In other embodiments, the food heater 810 can include heaters positioned within each roller to serve as an alternative or additional heating mechanism to induction heating.

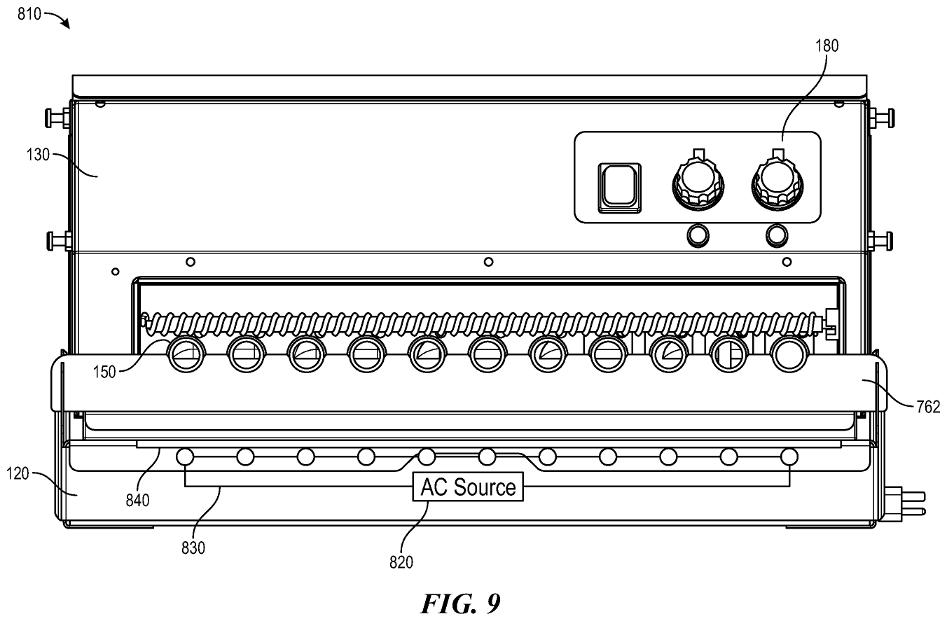

FIG. 9 is a front view of the food heater 810 in accordance with embodiments of the present technology. In the illustrated embodiment, the AC source 820, the induction wire 830, and the non-magnetic insulating board 840 are positioned inside the base 120 such that a single strand of wire extends below each roller 150, as illustrated in FIG. 8. While the AC source 820 is positioned below the portion of the induction wire 830 providing induction heating to the rollers 150 in the illustrated embodiment, the AC source 820 can be positioned anywhere relative to the induction wire 830. In the illustrated embodiment, the food heater 810 does not include heaters positioned within each roller 150.

The distance between the induction wire 830 and the rollers 150 can be optimized for induction heating. For example, if each of the rollers 150 has a diameter of 1 inch, the distance between the bottom of each of the rollers 150 and the induction wire 830 can be about 0.39 inches. The non-magnetic insulating board 840 can have a thickness of about 0.25 inches. In other embodiments, other dimensions can be used. The distance between each of the rollers 150 and the equivalent distance between each strand of induction wire 830 extending along each roller 150 can also be optimized for induction heating (e.g., to optimally place the rollers 150 within the electromagnetic field generated by the induction wire 830).

The following examples are illustrative of several embodiments of the present technology:
1. A food heater, comprising:
   a base;
   a drive unit mounted to the base, wherein the drive unit is pivotable between a first position relative to the base and a second position relative to the base;
   a plurality of rollers rotatably coupled to the drive unit, wherein individual ones of the rollers extend along a longitudinal axis, wherein the longitudinal axes of the rollers are parallel to one another, wherein the drive unit is configured to rotate the rollers about the corresponding longitudinal axes when the rollers are in the first position, and wherein the rollers are configured to be manually removable from the drive unit when the rollers are in the second position; and
   a control panel mounted to the drive unit and positioned to face in a direction parallel to the longitudinal axes.
2. The food heater of example 1, further comprising an actuation latch operably coupled to the drive unit, wherein the actuation latch is configured to be actuated to pivot the drive unit between the first and second positions, and wherein the control panel is positioned to face the actuation latch.
3. The food heater of examples 1-2, further comprising a drip tray configured to support the plurality of heaters and the plurality of rollers in the first position, wherein the control panel faces the drip tray.
4. The food heater of examples 1-3 wherein the base is configured to be positioned on a counter and has a user-facing portion and a rear portion opposite the user-facing portion, wherein the drive unit is mounted to the rear portion of the base, wherein the rollers are accessible by a user at the user-facing portion, and wherein the longitudinal axes of the rollers extend from the drive unit at the rear portion toward the user-facing portion.
5. The food heater of examples 1-4, further comprising a plurality of sprockets configured to be coupled to corresponding ones of the rollers, wherein the drive unit includes a motor operably coupled to a worm drive member, wherein the worm drive member is configured to engage the sprockets, and wherein the motor is configured to drive the worm drive member to rotate the sprockets to thereby rotate the rollers about the longitudinal axes.
6. The food heater of example 5 wherein rotation of the worm drive member is configured to pull the sprockets toward the drive unit, and wherein (a) the rollers each have generally the same dimensions as one another and (b) the sprockets each have generally the same dimensions as one another such that each of the rollers rotates at generally the same rate.
7. The food heater of examples 1-6, further comprising an induction wire coupled to the base and an alternating current source coupled to the induction wire, wherein the alternating current source is configured to supply alternating current to the induction wire such that the induction wire generates an electromagnetic field for inductively heating the rollers, and wherein the alternating current flows in a single direction under each of the rollers.
8. The food heater of examples 1-7, further comprising a plurality of heating elements mounted to the drive unit, wherein individual ones of the heating elements extend inside corresponding ones of the rollers, and wherein the rollers are concentrically aligned with the corresponding ones of the longitudinal axes.
9. A food heater, comprising:
   a base;
   a drive unit mounted to the base, wherein the drive unit is pivotable between a first position relative to the base and a second position relative to the base;
   a plurality of rollers coupled to the drive unit, wherein individual ones of the rollers extend along a longitudinal axis, wherein the longitudinal axes of the rollers are parallel to one another, wherein the drive unit is configured to rotate the rollers about the longitudinal axes when the rollers are in the first position, and wherein the rollers are configured to be manually removed from the drive unit when the rollers are in the second position;
   a drip tray configured to be positioned between the base and the plurality of rollers; and
   a support structure positioned over the drip tray and configured to support the rollers in the first position.
10. The food heater of example 9 wherein the support structure includes a plurality of grooves configured to support corresponding ones of the rollers in the first position.
11. The food heater of examples 9-10 wherein the support structure is configured to rotatably support distal end portions of the rollers.
12. The food heater of examples 9-11, further comprising a plurality of end caps configured to seal corresponding ones of the rollers, wherein the support structure is configured to contact the end caps when supporting the heaters and the rollers in the first position.
13. The food heater of examples 9-12 wherein the drip tray and the support structure form an integrated structure.
14. The food heater of examples 9-13, further comprising an induction wire coupled to the base and an alternating current source coupled to the induction wire, wherein the alternating current source is configured to supply alternating current to the induction wire such that the induction wire generates an electromagnetic field for inductively heating the rollers, and wherein the alternating current flows in a single direction under each of the rollers.
15. The food heater of examples 9-14, further comprising a plurality of heating elements mounted to the drive unit, wherein individual ones of the heating elements extend inside corresponding ones of the rollers.
16. A food heater, comprising:
   a base;
   a drive unit mounted to the base, wherein the drive unit is pivotable between a first position relative to the base and a second position relative to the base;
   a plurality of rollers rotatably coupled to the drive unit, wherein individual ones of the rollers extend along a longitudinal axis, wherein the longitudinal axes of the rollers are parallel to one another, wherein the drive unit is configured to rotate the rollers about the longitudinal axes when the rollers are in the first position, and wherein the rollers are configured to be manually removed from the drive unit when the rollers are in the second position; and
   a lift system mounted to the base, wherein the lift system is configured to be actuated to move the drive unit between the first and second positions, and wherein the lift system includes:
      a handle pivotable between a rest position and a lift position; and
      a lift bracket operably coupled between the drive unit and the handle,
      wherein the drive unit is in the first position when the handle is in the rest position, and wherein actuating the handle pivots the lift bracket such that the drive unit is in the second position when the handle is in the lift position.
17. The food heater of example 16 wherein the lift system further includes:
   a linkage including a first end portion pivotably coupled to the lift bracket and a second end portion opposite the first end portion;
   a lift shaft pivotably coupled between the handle and the second end portion of the linkage;
   a lift collar fixedly coupled to the lift shaft;
   a support structure coupled to the base and configured to support the lift shaft between the linkage and the lift collar; and
   a spring member positioned around the lift shaft and configured to be compressed between the lift collar and the support structure, wherein the spring member biases the handle toward the lift position.
18. The food heater of examples 16-17, further comprising a front cover removably coupled to the base proximate to the handle, wherein the front cover is configured to be removed when the handle is in the rest position.
19. The food heater of examples 16-18, further comprising an induction wire coupled to the base and an alternating current source coupled to the induction wire, wherein the alternating current source is configured to supply alternating current to the induction wire such that the induction wire generates an electromagnetic field for inductively heating the rollers, and wherein the alternating current flows in a single direction under each of the rollers.
20. The food heater of examples 16, 18, or 19 wherein the lift system further includes:
   a lift shaft pivotably coupled between the handle and the lift bracket;
   a support structure coupled to the base; and
   a spring member positioned around the lift shaft and including a first end portion coupled to the lift shaft and a second end portion coupled to the support structure, wherein the spring member is configured to be compressed and to bias the handle toward the lift position.

In general, the detailed description of embodiments of the present technology is not intended to be exhaustive or to limit the invention to the precise form disclosed above. While specific embodiments of, and examples for, the present technology are described above for illustrative purposes, various equivalent modifications are possible within the scope of the present technology, as those skilled in the relevant art will recognize. The teachings of the present technology provided herein can be applied to other systems, not necessarily the system described herein. The elements and acts of the various embodiments described herein can be combined to provide further embodiments. Any patents, applications and other references, including any that may be listed in accompanying filing papers, are incorporated herein by reference. Aspects of the present technology can be modified, if necessary, to employ the systems, functions, and concepts of the various references described above to provide yet further embodiments of the present technology.

These and other changes can be made to the present technology in light of the above Detailed Description. While the above description details certain embodiments of the present technology and describes the best mode contemplated, no matter how detailed the above appears in text, the present technology can be practiced in many ways. Details of the present technology may vary considerably in its implementation details, while still being encompassed by the present technology disclosed herein. As noted above, particular terminology used when describing certain features or aspects of the present technology should not be taken to imply that the terminology is being redefined herein to be restricted to any specific characteristics, features, or aspects of the present technology with which that terminology is associated. In general, the terms used in the following claims should not be construed to limit the present technology to the specific embodiments disclosed in the specification, unless the above Detailed Description section explicitly defines such terms. Accordingly, the actual scope of the invention encompasses not only the disclosed embodiments, but also all equivalent ways of practicing or implementing the present technology.

I/We claim:

1. A food heater, comprising:
a base;
a drive unit mounted to the base, wherein the drive unit is pivotable between a first position relative to the base and a second position relative to the base;
a plurality of rollers rotatably coupled to the drive unit, wherein individual ones of the rollers extend along a longitudinal axis, wherein the longitudinal axes of the rollers are parallel to one another, wherein the drive unit is configured to rotate the rollers about the corresponding longitudinal axes when the rollers are in the first position, and wherein the rollers are configured to be manually removable from the drive unit when the rollers are in the second position; and
a control panel mounted to the drive unit and positioned to face in a direction parallel to the longitudinal axes.

2. The food heater of claim 1, further comprising an actuation latch operably coupled to the drive unit, wherein the actuation latch is configured to be actuated to pivot the drive unit between the first and second positions, and wherein the control panel is positioned to face the actuation latch.

3. The food heater of claim 1, further comprising a drip tray configured to support the plurality of heaters and the plurality of rollers in the first position, wherein the control panel faces the drip tray.

4. The food heater of claim 1 wherein the base is configured to be positioned on a counter and has a user-facing portion and a rear portion opposite the user-facing portion, wherein the drive unit is mounted to the rear portion of the base, wherein the rollers are accessible by a user at the user-facing portion, and wherein the longitudinal axes of the rollers extend from the drive unit at the rear portion toward the user-facing portion.

5. The food heater of claim 1, further comprising a plurality of sprockets configured to be coupled to corresponding ones of the rollers, wherein the drive unit includes a motor operably coupled to a worm drive member, wherein the worm drive member is configured to engage the sprockets, and wherein the motor is configured to drive the worm drive member to rotate the sprockets to thereby rotate the rollers about the longitudinal axes.

6. The food heater of claim 5 wherein rotation of the worm drive member is configured to pull the sprockets toward the drive unit, and wherein (a) the rollers each have generally the same dimensions as one another and (b) the sprockets each have generally the same dimensions as one another such that each of the rollers rotates at generally the same rate.

7. The food heater of claim 1, further comprising an induction wire coupled to the base and an alternating current source coupled to the induction wire, wherein the alternating current source is configured to supply alternating current to the induction wire such that the induction wire generates an electromagnetic field for inductively heating the rollers, and wherein the alternating current flows in a single direction under each of the rollers.

8. The food heater of claim 1, further comprising a plurality of heating elements mounted to the drive unit, wherein individual ones of the heating elements extend inside corresponding ones of the rollers, and wherein the rollers are concentrically aligned with the corresponding ones of the longitudinal axes.

9. A food heater, comprising:
a base;
a drive unit mounted to the base, wherein the drive unit is pivotable between a first position relative to the base and a second position relative to the base;
a plurality of rollers coupled to the drive unit, wherein individual ones of the rollers extend along a longitudinal axis, wherein the longitudinal axes of the rollers are parallel to one another, wherein the drive unit is configured to rotate the rollers about the longitudinal axes when the rollers are in the first position, and wherein the rollers are configured to be manually removed from the drive unit when the rollers are in the second position;
a drip tray configured to be positioned between the base and the plurality of rollers; and
a support structure positioned over the drip tray and configured to support the rollers in the first position.

10. The food heater of claim 9 wherein the support structure includes a plurality of grooves configured to support corresponding ones of the rollers in the first position.

11. The food heater of claim 9 wherein the support structure is configured to rotatably support distal end portions of the rollers.

12. The food heater of claim 9, further comprising a plurality of end caps configured to seal corresponding ones of the rollers, wherein the support structure is configured to contact the end caps when supporting the heaters and the rollers in the first position.

13. The food heater of claim 9 wherein the drip tray and the support structure form an integrated structure.

14. The food heater of claim 9, further comprising an induction wire coupled to the base and an alternating current source coupled to the induction wire, wherein the alternating current source is configured to supply alternating current to the induction wire such that the induction wire generates an electromagnetic field for inductively heating the rollers, and wherein the alternating current flows in a single direction under each of the rollers.

15. The food heater of claim 9, further comprising a plurality of heating elements mounted to the drive unit, wherein individual ones of the heating elements extend inside corresponding ones of the rollers.

16. A food heater, comprising:
a base;
a drive unit mounted to the base, wherein the drive unit is pivotable between a first position relative to the base and a second position relative to the base;
a plurality of rollers rotatably coupled to the drive unit, wherein individual ones of the rollers extend along a longitudinal axis, wherein the longitudinal axes of the rollers are parallel to one another, wherein the drive unit is configured to rotate the rollers about the longitudinal axes when the rollers are in the first position, and wherein the rollers are configured to be manually removed from the drive unit when the rollers are in the second position; and
a lift system mounted to the base, wherein the lift system is configured to be actuated to move the drive unit between the first and second positions, and wherein the lift system includes:
a handle pivotable between a rest position and a lift position; and
a lift bracket operably coupled between the drive unit and the handle,
wherein the drive unit is in the first position when the handle is in the rest position, and wherein actuating the handle pivots the lift bracket such that the drive unit is in the second position when the handle is in the lift position.

17. The food heater of claim 16 wherein the lift system further includes:
a linkage including a first end portion pivotably coupled to the lift bracket and a second end portion opposite the first end portion;
a lift shaft pivotably coupled between the handle and the second end portion of the linkage;
a lift collar fixedly coupled to the lift shaft;
a support structure coupled to the base and configured to support the lift shaft between the linkage and the lift collar; and
a spring member positioned around the lift shaft and configured to be compressed between the lift collar and the support structure, wherein the spring member biases the handle toward the lift position.

18. The food heater of claim 16, further comprising a front cover removably coupled to the base proximate to the handle, wherein the front cover is configured to be removed when the handle is in the rest position.

19. The food heater of claim 16, further comprising an induction wire coupled to the base and an alternating current source coupled to the induction wire, wherein the alternating current source is configured to supply alternating current to the induction wire such that the induction wire generates an electromagnetic field for inductively heating the rollers, and wherein the alternating current flows in a single direction under each of the rollers.

20. The food heater of claim 15 wherein the lift system further includes:
a lift shaft pivotably coupled between the handle and the lift bracket;
a support structure coupled to the base; and
a spring member positioned around the lift shaft and including a first end portion coupled to the lift shaft and a second end portion coupled to the support structure, wherein the spring member is configured to be compressed and to bias the handle toward the lift position.
